(19) United States
(12) Patent Application Publication
(10) Pub. No.: US 2004/0229655 A1
(43) Pub. Date: Nov. 18, 2004

(54) Mobile terminal having time shift function and method thereof

(76) Inventor: Yun-Nam Jang, Ichon-shi (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/749,495

(22) Filed: Dec. 31, 2003

(30) Foreign Application Priority Data
May 13, 2003 (KR) 2003-30111

(51) Int. Cl. H04M 1/00; H04B 1/38

(52) U.S. Cl. 455/566; 455/412.1; 455/550.1

(57) ABSTRACT

Disclosed is a mobile terminal having a time shift function and a method of implementing the same. The mobile terminal includes: a transceiver unit for receiving multimedia data through a wireless channel; a control unit for controlling the mobile terminal to store the multimedia data and to transform stored multimedia data into image and voice data after passing a predetermined length of time; a display unit for receiving the image and voice data and displaying the image and voice data; a keypad input unit for receiving the time shift selection signal; and a memory unit for storing the multimedia data and transmitting stored multimedia data to the control unit by the control unit. The effect of the present invention is such that a motion picture and live broadcast can be watched on the screen of the terminal at a later time as if they are currently being broadcasted.

### FIELD OF THE INVENTION

The present invention relates to a mobile terminal having a time shift function and a method thereof; and, more particularly, to a mobile terminal having a time shift function and a method of implementing the time shift function by storing broadcasting multimedia data in a memory unit within a predetermined time and playing the stored multimedia data after a predetermined time exceed.

### DESCRIPTION OF RELATED ART

Recently, it has been getting popular to subscribe mobile data communication services by using a mobile terminal. For subscribing mobile data communication service, there are various mobile terminals developed, e.g., a personal digital assistant (PDA), a hand personal computer (HPC), a web pad, a notebook, a smart phone, a wireless application protocol (WAP) enabled phone, a palm PC, an e-book terminal and a hand-held terminal (HHT). Furthermore, as developing various mobile terminals, there are various mobile data communication services available, e.g., wireless Internet services, mobile computing services, wireless data communication services and satellite communication services. Such a development of mobile data communication service and mobile terminals provide a wide variety of mobile solutions, mobile contents, network systems and peripherals.

The mobile solution includes an operating system (OS) intended for mobile devices and software applications compatible with the relevant OS, development tools, mobile browsers, dynamic image solutions, sound-based authentication/voice recognition solutions, location-based solutions. The mobile content includes a mobile portal, a download service, an information service, a global positioning system service, a mobile commerce and suchlike. The network system includes an optical transmission device, a repeater, a wireless local area network (LAN), a Bluetooth device, a mobile modem and suchlike. The peripheral includes a mobile keyboard, a printer, a digital camera, an MP3 player and suchlike.

Amongst a wide variety of mobile data communication services, a wireless broadcasting service specifically targeted at a mobile terminal stands out the most. As an advantage of a wireless broadcasting service, marketability and flexibility thereof, in cooperation with the advanced technology of a mobile data communication service, are factored into wide usage of such service.

FIG. 1 is a block diagram of a wireless broadcast system.

The wireless broadcast system includes a contents supply system 110, a network 120, a mobile communication provider 130, and a mobile terminal 140 specifically designed to handle wireless broadcast data. The contents supply system 110 receives contents including multimedia data from the contents provider including a radio/television broadcaster as well as individual broadcasting data via a terminal for data communication, e.g., a cellular phone and a notebook. And then, the contents supply system 110 assigns a wireless transmission channel to each mobile terminal and transmits contents including the multimedia data to the mobile terminals. The network 120 includes a wired/wireless Internet, private line and so forth. The mobile communication provider 130 multicasts streamed multimedia data to mobile terminal 140 through wireless communication channels by setting up a data transmission protocol that is identical to the contents supply system 110. The mobile terminal 140 stores interface programs for processing wireless broadcast data via a keypad, playing one or more types of audio or moving picture files such as MP4-type, asf-type, rm-type, and controlling a WIP-based platform wireless internal protocol. The term ‘WIP’ stands for Wireless Internet Protocol and includes a wireless application protocol (WAP), mobile explore (ME) and binary runtime environment for wireless (BREW).

However, in the conventional wireless broadcast systems, if a user has a situation not to watch live broadcast program in a certain period time such as a call is received to the mobile terminal during watching live broadcast program by using the mobile terminal, the user does not have any method to watch missed portion of live broadcast program.

### SUMMARY OF THE INVENTION

It is, therefore, an object of the present invention to provide a mobile terminal having a time shift function and a method thereof in which multimedia data received in real-time can be provided to a mobile user at a desired time.

In accordance with an aspect of the present invention, there is provided a mobile terminal having a time shift function including: a transceiver unit for receiving multimedia data through a wireless channel; a control unit for controlling the mobile terminal to store the multimedia data by receiving a time shift selection signal and to transform stored multimedia data into image and voice data after passing a predetermined length of time; a display unit for receiving the image and voice data and displaying the image and voice data; a keypad input unit for receiving the time shift selection signal; and a memory unit for storing the multimedia data and transmitting stored multimedia data to the control unit by the control unit.

In accordance with another aspect of the present invention, there is provided a method for implementing a time shift function in a mobile terminal, the method including the steps of: a) selecting a time shift function; b) receiving multimedia data in the mobile terminal and storing the received multimedia data in a buffer in a memory unit; c) determining whether the predetermined length of time is exceed and performing step b) if the predetermined time is not exceed as a result of determination; and d) if the predetermined time is exceed, passing the multimedia data to a display unit, playing the multimedia data for a user and at the same time, simultaneously and continually storing currently received multimedia data.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram of a wireless broadcast system;

FIG. 2 is a block diagram illustrating a mobile terminal having a time shift function in accordance with an embodiment of the present invention; and

FIG. 3 is a flow chart describing a time shift method in accordance with an embodiment of the present invention.

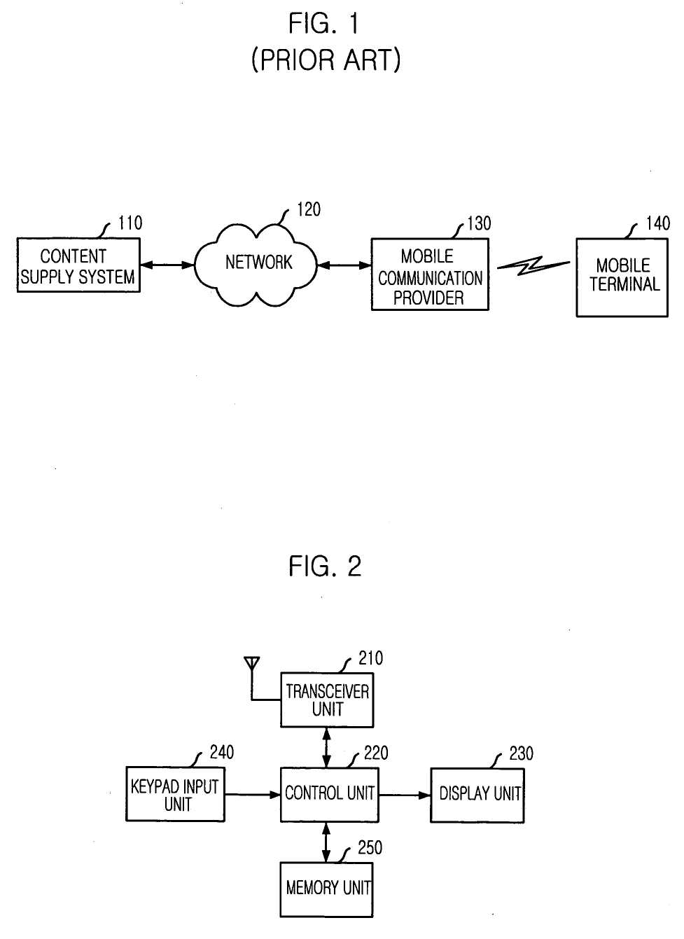

### DETAILED DESCRIPTION OF THE INVENTION

Other objects and aspects of the invention will become apparent from the following description of the embodiments with reference to the accompanying drawings, which is set forth hereinafter.

FIG. 2 is a block diagram illustrating a mobile terminal having a time shift function in accordance with an embodiment of the present invention. Referring to FIG. 2, the mobile terminal includes a transceiver unit 210, a control unit 220, a display unit 230, a keypad input unit 240 and a memory unit 250.

The transceiver unit 210 receives multimedia data through a wireless channel and passes the multimedia data to the control unit 220. The control unit 220 transforms the multimedia data into video and audio data and transmits the image data and the voice data to the display unit 230. Also, the control unit 220 receives an interface program in the memory unit 250 for controlling wireless broadcasting data when the wireless broadcast mode is active. The control unit 220 receives a selection signal entered via the keypad input unit 240 by using the interface program and recognizes the selection signal as a broadcasting control selection signal.

The display unit 230 receives the video and audio data to produce a sound, picture and movie. The keypad input unit 240 receives the selection signal including a time shift selection signal from the use and outputs the selection signal to the control unit 220.

The memory unit 250 stores the interface program and the multimedia data and provides the stored multimedia data to the control unit 220. Also, the multimedia data is either stored in the memory or transmitted to the control unit 220.

At first, a user selects live broadcasting program via the keypad input unit 240. The control unit 220 activates the interface program for wireless broadcasting data in order to turn in wireless broadcasting mode. After activating the interface program, the transceiver unit 210 receives multimedia data of live broadcasting program through a wireless channel and providing the received multimedia data to display unit 230. The display unit 230 displays the received multimedia data for the user.

Here, the steps of implementing a time shift function in the terminal are performed in order. Firstly, the user selects the time shift function via the keypad input unit 240. Secondly, the control unit 220 stored subsequently received multimedia data in a buffer of the memory unit 250. When a predetermined length of time is exceeded, the control unit 220 passes the multimedia data stored in the buffer of the memory unit 250 to the display unit 230 in the form of a sound, picture and movie for displaying the multimedia data to the user. At the same time of passing and playing the multimedia data, currently received multimedia data is simultaneously stored in the memory unit 250 on a continuing basis.

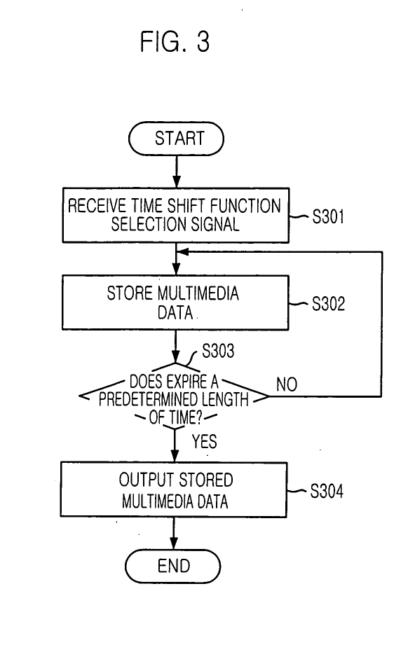

FIG. 3 is a flow chart describing a time shift method in accordance with an embodiment of the present invention.

At step S301, the user selects a time shift function via the keypad input unit 240.

At step S302, the control unit 220 stores multimedia data in a buffer of the memory unit 250 instead of passing the multimedia data to the display unit 230 for displaying the multimedia data for user.

Following on from the step S302, the control unit 220 determines if the length of a live broadcast exceeds a predetermined length of time. Here, the predetermined length of time should be set on a case-by-case basis in a way that is appropriate to each mobile terminal. Also the user can set the above-mentioned time-related set-up on the terminal to meet his needs. In summary, the predetermined length of time can be either preset on a case-by-case basis in a way that is appropriate to each mobile terminal or explicitly entered by a user via the keypad input unit to meet his ends.

At this stage of the process of implementing a time shift function in the mobile terminal, there exists two alternative possibilities. One possibility is a situation where the live broadcasting program is end before the predetermined length of time is exceed. In this case, the multimedia data is stored in a buffer of the memory unit 250, at step S303.

The other possibility is a situation where the live broadcasting program is still running when the predetermined length of time is exceed. In this case, the control unit 220 passes the multimedia data on to the user via the display unit 230 in the form of a sound, picture and movie and at the same time of passing and playing the multimedia data, currently the received multimedia data is simultaneously stored in the memory unit 250 on a continuing basis.

The mobile terminal having a time shift function enables a user to watch broadcasting data at a later time as if they are currently being broadcasted.

While the present invention has been described with respect to certain preferred embodiments, it will be apparent to those skilled in the art that various changes and modifications may be made without departing from the scope of the invention as defined in the following claims.

What is claimed is:

1. A mobile terminal having a time shift function, comprising:
a keypad input unit for receiving the time shift selection signal;
a memory unit for storing the multimedia data;
a transceiver unit for receiving multimedia data through a wireless channel;
a control unit for controlling the memory unit to store the multimedia data by receiving the time shift function selection signal and to output the multimedia data stored in the memory unit after passing a predetermined length of time; and
a display unit for receiving the image and voice data and displaying the image and voice data.

2. The mobile terminal as recited in claim 1, wherein the predetermined length of time is set by a user through the key pad input unit.

3. A method for implementing a time shift function in a mobile terminal, the method comprising the steps of:
a) receiving a time shift function selection signal;
b) receiving and storing multimedia data in a memory unit;
c) determining whether a predetermined length of time is exceed and performing step b) if the predetermined time is not exceed; and
d) if the predetermined time is exceed, outputting the multimedia data through a display unit.

4. The method as recited in claim 3, wherein the predetermined length of time is set by a user through a keypad input unit.
